(19) United States
(12) Patent Application Publication
(10) Pub. No.: US 2024/0260779 A1
(43) Pub. Date: Aug. 8, 2024

(54) CONTAINER INCLUDING AGITATOR FOR MICROWAVE SOUS VIDE FUNCTION

(71) Applicant: Midea Group Co., Ltd., Beijiao (CN)

(72) Inventors: Connor Walsh, Alexandria, KY (US); John Kenneth Hooker, Louisville, KY (US)

(21) Appl. No.: 18/618,000

(22) Filed: Mar. 27, 2024

Related U.S. Application Data
(63) Continuation of application No. 16/447,491, filed on Jun. 20, 2019.

(51) Int. Cl. A47J 27/10; A47J 36/16; A47J 36/32; A47J 43/046; H05B 1/02; H05B 6/64; H05B 6/68; H05B 6/78; H05B 6/80

(52) U.S. Cl. CPC A47J 27/10; A47J 36/165; A47J 36/32; A47J 43/046; H05B 6/6408; H05B 6/782; H05B 6/80; H05B 1/0263; H05B 1/0269; H05B 6/6455; H05B 6/647; H05B 6/687; H05B 6/802

(57) ABSTRACT

A microwave oven container may include a body for containing a liquid, an agitator projecting through a bottom wall of the body to agitate the liquid contained in the body, where the agitator includes a first end located in the body and a second end located exterior to the body. The second end of the agitator is able to couple with a turntable drive of a microwave oven to power movement of the agitator in response to rotation of the turntable drive. The container may also include a cage located within the body that substantially surrounds the first end of the agitator and includes a plurality of openings to allow liquid contained in the body to pass through the cage.

### BACKGROUND

Sous vide cooking has become an increasingly popular manner of cooking, as it has been found that for many foods, sous vide cooking can produce extremely tender, flavorful, and consistent results. Traditional cooking typically requires a high temperature energy source to cook food from the outside until the interior of the food reaches a desired temperature; in contrast, sous vide cooking involves cooking food at a much lower temperature and generally for a longer period of time. As a result, sous vide cooking is much less susceptible to burning, drying out, or otherwise overcooking the exterior of a food due to the substantially reduced temperature differential between the interior and the exterior of the food during cooking.

Typically, for sous vide cooking, the food to be cooked is placed in a bag, in some instances with spices, marinades, or other flavorings. Generally, it is desirable to remove most or all of the air from the bag in order to minimize the buoyancy of the bag; therefore, in some instances, a vacuum sealer is used. The bag is then immersed in a container of water (e.g., a pot) heated to a fixed temperature, which in many instances is the desired final internal temperature of the food being cooked. Thus, for example, if it is desired to cook a medium rare steak using sous vide cooking, the water may be held at a temperature of about 130 degrees Fahrenheit. The food is then cooked for sufficient time to bring the food to the same temperature as the water throughout so that the interior of the food cooks at the same temperature as the exterior of the food.

It has been found, however, that sous vide cooking generally requires precise control over the temperature of the water throughout the cooking process, and as a result, various dedicated sous vide cooking devices, also known as immersion cookers, have been developed to address the specific needs of sous vide cooking. A typical sous vide cooking device is designed to clip onto the side of a container such as a pot and includes a heating element, a temperature sensor, and a mechanism for circulating water such that a consistent water temperature can be maintained throughout the container.

Conventional sous vide cooking devices, however, have been found to suffer from a number of drawbacks. For example, conventional sous vide devices are separate kitchen appliances that must be purchased and stored by a user. Furthermore, these devices typically sit in a pot of water or have a water reservoir built-in, and typically specify that the water be pre-heated before the food is placed in the water.

### SUMMARY

The herein-described embodiments address these and other problems associated with the art by providing a container with an integrated agitator that may be driven by the existing turntable assembly of a microwave oven. In one aspect, such a microwave oven container includes: a body configured to contain a liquid; an agitator projecting through a bottom wall of the body and configured to agitate liquid contained in the body, the agitator having a first end located within the body and a second end located external to the body, the second end adapted to couple with a turntable drive of a microwave oven to power movement of the agitator in response to rotation of the turntable drive; and a cage located within the body and substantially surrounding the first end of the agitator, where the cage includes a plurality of openings to allow liquid contained in the body to pass through the cage.

In some embodiments, the container additionally includes a rotary seal positioned to seal the bottom wall of the body proximate the agitator.

In some embodiments, the agitator includes a propeller located at the first end thereof, where the cage is configured to substantially surround the propeller. In some embodiments, the agitator includes an agitator selected from a group consisting of: a three blade propeller, a paddle, or a helical agitator located at the first end thereof.

In some embodiments, the container is configured for use in sous vide cooking in the microwave oven and the cage is configured to separate the agitator from a sous vide bag in a submerged position within the liquid contained by the body of the container. In some such embodiments, the cage forms a support for the sous vide bag.

In some embodiments, the second end of the agitator includes a connector adapted to removably couple with the turntable drive of the microwave oven. In some such instances, a mating profile of the connector matches that of a turntable of the microwave oven such that the container is interchangeable with the turntable.

In another aspect, a microwave oven includes: a housing with a cooking cavity; and a container that includes: a body configured to contain a liquid; an agitator projecting through a bottom wall of the body and configured to agitate liquid contained in the body, the agitator including a first end located within the body and a second end located external to the body, the second end adapted to couple with a turntable drive of a microwave oven to power movement of the agitator in response to rotation of the turntable drive; and a cage located within the body and substantially surrounding the first end of the agitator, where the cage includes a plurality of openings to allow liquid contained in the body to pass through the cage.

In some embodiments, the second end of the agitator includes a connector that is adapted to removably couple with the turntable drive of the microwave oven. In some such embodiments, a mating profile of the connector matches that of a turntable of the microwave oven such that the container is interchangeable with the turntable.

In some embodiments, the container further includes a rotary seal positioned to seal the bottom wall of the body proximate the agitator.

In some embodiments, the container is configured for use in sous vide cooking in the microwave oven and the cage is configured to separate the agitator from a sous vide bag in a submerged position within the liquid contained by the body of the container. In other embodiments, the microwave oven additionally includes: a microwave cooking element located within the housing to generate cooking energy within the cooking cavity; a temperature sensor positioned to sense temperature within the cooking cavity of the housing; and a controller located in the housing and configured to: initiate a dedicated sous vide cooking cycle in response to user input and after placement of the container containing the liquid and a food item to be cooked into the cooking cavity; monitor a temperature of the liquid contained by the container during the dedicated sous vide cooking cycle using the temperature sensor; and control the microwave cooking element in response to the monitored temperature to maintain a substantially constant temperature of the liquid during at least a portion of the dedicated sous vide cooking cycle.

In some embodiments, the temperature sensor is an infrared sensor, and the temperature sensor wirelessly senses temperature within the cooking cavity of the housing. In some embodiments, the temperature sensor is disposed on a bottom wall of the cooking cavity.

In some embodiments, the agitator agitates constantly during the dedicated sous vide cycle. In other embodiments, the controller is configured to control the agitator in response to the monitored temperature. In some such embodiments, the controller is configured to control the agitator in response to the monitored temperature by changing a speed of rotation. In other such embodiments, the controller is configured to control the agitator in response to the monitored temperature by changing a direction of rotation.

In yet another aspect, a method of sous vide cooking in a microwave oven, where the microwave oven includes a housing including a cooking cavity, a microwave cooking element disposed within the housing to generate cooking energy within the cooking cavity, a turntable drive projecting into the cooking cavity and a controller disposed in the housing, includes: initiating, by the controller, a cooking cycle to cook a food item disposed in a container located in the cooking cavity; circulating water in a water bath disposed in the container during the cooking cycle by driving the turntable drive to drive an agitator that is removably coupled to the turntable drive, that projects through a bottom wall of the container, and that is separated from the food item by a cage that surrounds a portion of the agitator disposed within the container; monitoring, by a temperature sensor, a temperature of the water bath disposed in the container during the cooking cycle; and controlling, by the controller, the microwave cooking element in response to the monitored temperature to maintain a substantially constant temperature for the water bath during at least a portion of the cooking cycle.

In some embodiments, the cooking cycle is a dedicated sous vide cycle.

In some embodiments, the method additionally includes controlling, by the controller, the agitator by adjusting a speed of rotation of the turntable drive during the cooking cycle. In other embodiments, the method additionally includes controlling, by the controller, the agitator by adjusting a direction of rotation of the turntable drive during the cooking cycle.

In some embodiments, the agitator includes a first end located within the container and a second end located external to the container, the second end including a connector adapted to removably couple with the turntable drive of the microwave oven to power movement of the agitator in response to rotation of the turntable drive. In some such embodiments, a mating profile of the connector matches that of a turntable of the microwave oven.

These and other advantages and features, which characterize the invention, are set forth in the claims annexed hereto and forming a further part hereof. However, for a better understanding of the invention, and of the advantages and objectives attained through its use, reference should be made to the Drawings, and to the accompanying descriptive matter, in which there is described example embodiments of the invention. This summary is merely provided to introduce a selection of concepts that are further described below in the detailed description, and is not intended to identify key or essential features of the claimed subject matter, nor is it intended to be used as an aid in limiting the scope of the claimed subject matter.

### BRIEF DESCRIPTION OF THE DRAWINGS

FIG. 1 is a perspective view of a microwave oven consistent with some embodiments of the invention.

FIG. 2 is a perspective view of the microwave oven of FIG. 1 with various internal components of the microwave oven illustrated.

FIG. 3 is a block diagram of an example control system for the microwave oven of FIG. 1.

FIG. 4 is a front view of a container configured for use in a microwave oven consistent with some embodiments of the invention.

FIG. 5 is a top view of the container of FIG. 4.

FIG. 6A-B are partial front views of a mating profile of a connector to a turntable drive of a microwave oven consistent with some embodiments of the invention. FIG. 6A is a partial view of the mating profile of the container of FIG. 4; FIG. 6B is a partial view of the mating profile of a turntable.

FIG. 7 is an operational flow for sous vide cooking in a microwave oven consistent with some embodiments of the invention.

FIGS. 8A-I illustrate various types of agitators that may be used consistent with some embodiments of the invention. FIG. 8A illustrates a first embodiment of a three blade propeller; FIG. 8B illustrates a first embodiment of a paddle agitator; FIG. 8C illustrates a second embodiment of a paddle agitator; and, FIG. 8D illustrates an embodiment of a centrifugal propeller. FIG. 8E illustrates a first embodiment of a bidirectional propeller. FIG. 8F illustrates a second embodiment of a bidirectional propeller, an embodiments in which the blades curve upward. FIG. 8G illustrates a third embodiment of a bidirectional propeller. FIG. 8H illustrates a fourth embodiment of a bidirectional propeller, an embodiment in which the blades are twisted. FIG. 8I illustrates another embodiment of a propeller in which there are six blades curved upward.

FIGS. 9A-B illustrate a container configured for use in a microwave oven consistent with some embodiments of the invention. FIG. 9A is a perspective view of a container for use in a microwave oven; FIG. 9B is a perspective view of a support for use with the container illustrated in FIG. 9A.

### DETAILED DESCRIPTION

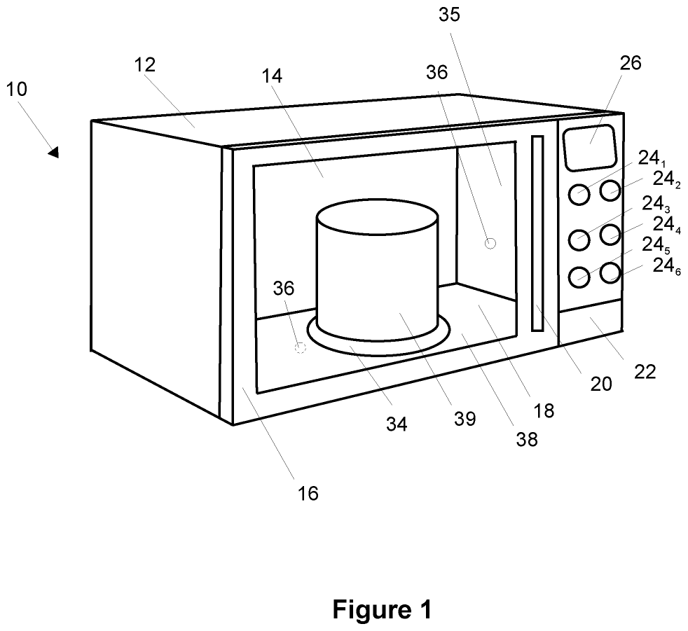

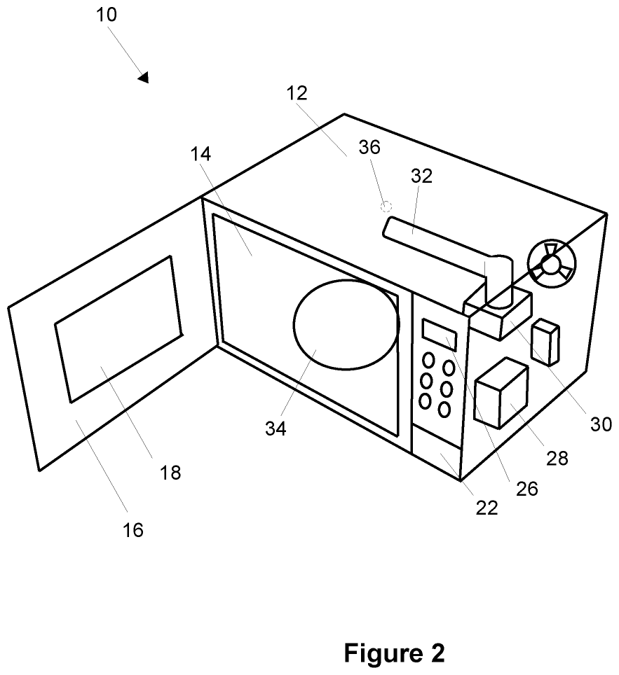

Turning now to the drawings, wherein like numbers denote like parts throughout the several views, FIGS. 1 and 2 illustrate an example microwave oven 10 in which the various technologies and techniques described herein may be implemented. Microwave oven 10 is a residential or commercial-type microwave oven, and as such includes a housing 12, which further includes a cooking cavity 14, as well as a door 16 disposed adjacent the respective opening of the cooking cavity 14. In some embodiments, the door 16 may further include a window 18 that allows a user to view the items inside the cooking cavity 14 and a handle 20. In other embodiments, in place of, or in addition, to the handle 20, the microwave oven 10 may include a button 22 that a user may press to trigger the opening of the door 16.

The microwave oven 10 may also include one or more user activated controls 24₁₋ₙ, which may be in the form of buttons, knobs, a touchscreen, or the like. In some embodiments, these user activated controls 24₁₋ₙ may be used to preprogram a cooking time and/or a cooking temperature. In other embodiments, these user activated controls 24₁₋ₙ may be used to selected one or more preset conditions for a particular a food item to be cooked or a particular desired action (e.g. “popcorn”, “defrost”, “frozen pizza”, etc.). In some embodiments, the preset conditions may include a dedicated sous vide cycle. The microwave oven 10 may also include a display 26, which may be used to convey a variety of information to a user. For example, in some embodiments, the display 26 may be used to display the time when the microwave oven 10 is not in use. In other embodiments, the display 26 may be used to display cooking times and/or temperatures.

Referring particularly to FIG. 2, various internal components of the microwave oven 10 are illustrated. A transformer 28 may covert standard 120 volt household electricity to about 4,000 volts (or higher depending on the specific microwave oven) in order to provide power to one or more cooking elements (i.e., a magnetron) 30. This conversion allows the magnetron or microwave cooking element 30 to generate microwaves from the increased voltage. This increased voltage may heat a filament (not shown) at the center of the microwave cooking element 30, which results in the release of electrons. The movement of these electrons throughout the microwave cooking element 30 may be facilitated by magnets, which may be, for example, shaped in the form of rings, which generate microwaves at a desired frequency. Typically, household microwave ovens operate at a microwave frequency of about 2.45 gigahertz; however, this is not intended to be limiting, and in some embodiments may vary. Once generated at the desired frequency, the microwaves are transmitted into and throughout the cooking cavity 14 by an antenna 32 coupled with the microwave cooking element 30. The microwaves bounce around the cooking cavity 14 and penetrate the food item(s) during the operation of the microwave oven 10, which results in the heating (and cooking) of the food item(s).

The microwave oven 10 may further include a turntable assembly 34 disposed inside the cooking cavity 14. In some embodiments, the turntable assembly 34 may be positioned centrally in the cooking cavity 14; although this is not intended to be limiting. One or more food items may be placed on the turntable assembly 34, so that as the turntable assembly 34 rotates so do the one or more food items contained thereon. This rotation may facilitate more even heating (or cooking) of the food item(s). In some instances, such a turntable may be configured to be turned on or off for different types of cooking cycles, and may be reversible in some embodiments. Moreover, in some embodiments it may be desirable to use a variable speed drive for turntable assembly 34 to provide additional control over turntable speed.

Additionally, the microwave oven 10 may include a temperature sensor 36 positioned so as to be able to sense a temperature within the cooking cavity. In some instances, the temperature sensor 36 may be located on a back or sidewall 35 of the cooking cavity 14 and may be capable of wirelessly sensing temperature. For example, in some embodiments, such a temperature sensor 36 may be positioned approximately one-third to one-half-way up the sidewall 35 from the bottom surface 38, so as to allow the temperature sensor 36 to be able to sense the temperature of a water bath used for sous vide cooking. In other instances, the temperature sensor 36 may be located on a lower surface of the cooking cavity (illustrated in FIG. 1 with broken line). In still other instances, the temperature sensor 36 may be located on either an upper surface of the cooking cavity (illustrated in FIG. 2 with broken line) or on a lower surface of the cooking cavity (illustrated in FIG. 1 with broken line). The temperature sensor 36 may be an infrared (IR) sensor, although this is not to be understood as limiting as any temperature sensor temperature capable of functioning without interfering with the microwave energy used within the cooking cavity 14 may be used. In some instances, in particular where sous vide cooking is desired, the IR sensor may be calibrated to read the temperature of a water bath with a container 39. Other temperature sensors capable of wirelessly sensing temperature, e.g., thermal imaging sensors, may also be used. In addition, other temperature sensors, e.g., wired probes, turntable-mountable sensors, immersible sensors, wireless sensors, etc., may also be used in other embodiments, although it will be appreciated that a wall-mounted sensor such as an IR sensor provides advantages in terms of being unobtrusive and not requiring substantial user intervention.

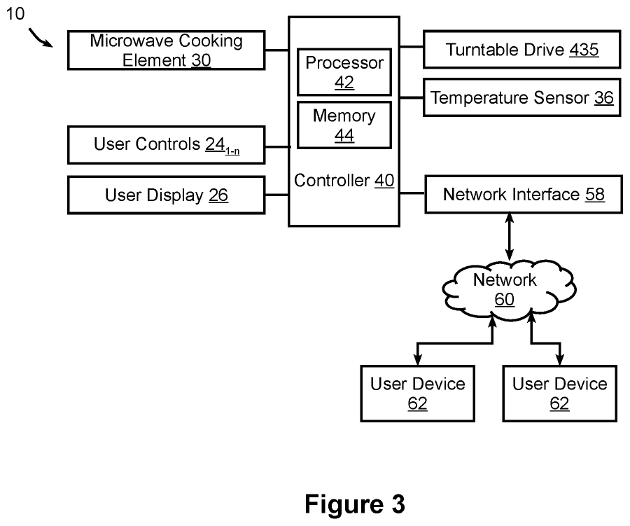

A microwave oven consistent with the description herein may also generally include one or more controllers configured to control the operation of the microwave oven 10 as well as manage interaction with a user. FIG. 3, for example, illustrates an example embodiment of a microwave oven 10 including a controller 40 that receives inputs from a number of components and drives a number of components in response thereto. Controller 40 may for example, include one or more processors 42 and a memory 44 within which may be stored program code for execution by the one or more processors. The memory may be embedded in controller 40, but may also be considered to include volatile and/or non-volatile memories, cache memories, flash memories, programmable read-only memories, read-only memories, etc., as well as memory storage physically located elsewhere from controller 40, e.g., in a mass storage device or on a remote computer interfaced with controller 40.

As shown in FIG. 3, controller 40 may be interfaced with various components, including a microwave cooking element 30, a motor or other drive for turntable drive 435, one or more user activated controls 24₁₋ₙ for receiving user input (e.g., various combinations of switches, knobs, buttons, sliders, touchscreens or touch-sensitive displays, microphones or audio input devices, image capture devices, etc.), and one or more displays 26 (including various indicators, graphical displays, textual displays, speakers, etc.), as well as various additional components suitable for use in a microwave oven.

Controller 40 may also be interfaced with a temperature sensor 36 that is capable of sensing a temperature within the cooking cavity 14. In some embodiments, the temperature sensor 36 may sense temperature wirelessly, and in some embodiments, temperature sensor 36 may also be wirelessly coupled to controller 40; although in other embodiments, the temperature sensor 36 may be coupled to the controller 40 through one or more wired connections.

In some embodiments, controller 40 may also be coupled to one or more network interfaces 58, e.g., for interfacing with external devices via wired and/or wireless networks such as Ethernet, Wi-Fi, Bluetooth, NFC, cellular and other suitable networks, collectively represented in FIG. 3 at 60. Network 60 may incorporate in some embodiments a home automation network, and various communication protocols may be supported, including various types of home automation communication protocols. In other embodiments, other wireless protocols, e.g., Wi-Fi or Bluetooth, may be used.

In some embodiments, microwave oven 10 may be interfaced with one or more user devices 62 over network 60, e.g., computers, tablets, smart phones, wearable devices, etc., and through which microwave oven 10 may be controlled and/or microwave oven 10 may provide user feedback.

In some embodiments, controller 40 may operate under the control of an operating system and may execute or otherwise rely upon various computer software applications, components, programs, objects, modules, data structures, etc. In addition, controller 40 may also incorporate hardware logic to implement some or all of the functionality disclosed herein. Further, in some embodiments, the sequences of operations performed by controller 40 to implement the embodiments disclosed herein may be implemented using program code including one or more instructions that are resident at various times in various memory and storage devices, and that, when read and executed by one or more hardware-based processors, perform the operations embodying desired functionality. Moreover, in some embodiments, such program code may be distributed as a program product in a variety of forms, and that the invention applies equally regardless of the particular type of computer readable media used to actually carry out the distribution, including, for example, non-transitory computer readable storage media. In addition, it will be appreciated that the various operations described herein may be combined, split, reordered, reversed, varied, omitted, parallelized, and/or supplemented with other techniques known in the art, and therefore, the invention is not limited to the particular sequences of operations described herein.

Numerous variations and modifications to the microwave oven illustrated in FIGS. 1-3 will be apparent to one of ordinary skill in the art, as will become apparent from the description below. Therefore, the invention is not limited to the specific implementations discussed herein.

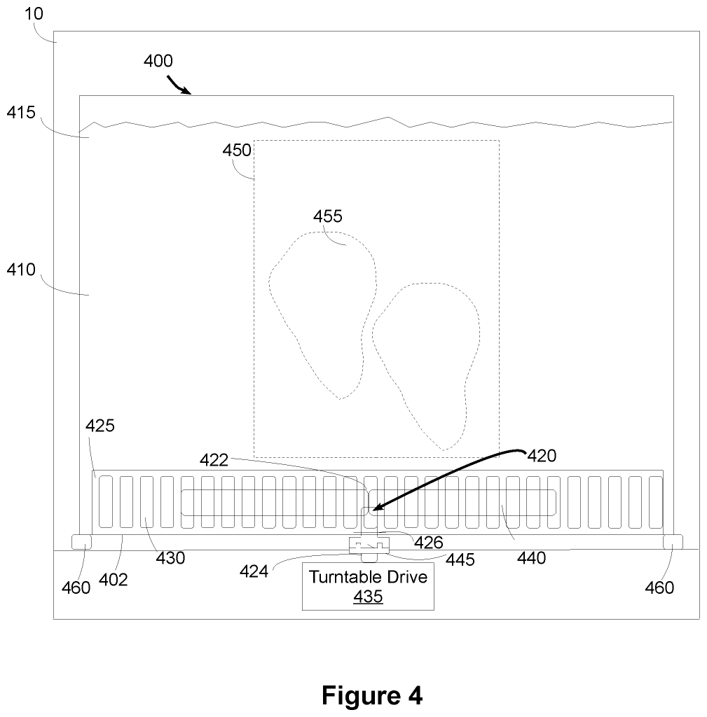

Now turning to FIGS. 4-6A, an exemplary container 400 for use in microwave oven 10 (e.g. for sous vide cooking) is illustrated. Such a container 400 may include a body 410 for containing a liquid 415 to be mixed. The container may be constructed of any microwave safe material (e.g. glass, plastic, or the like). While primarily described herein with respect to sous vide cooking, where the liquid is likely to be a water bath, this is not intended to be limiting. In some instances, the container 400 may be used to mix and cook various other liquids or solids, either alone or in combination.

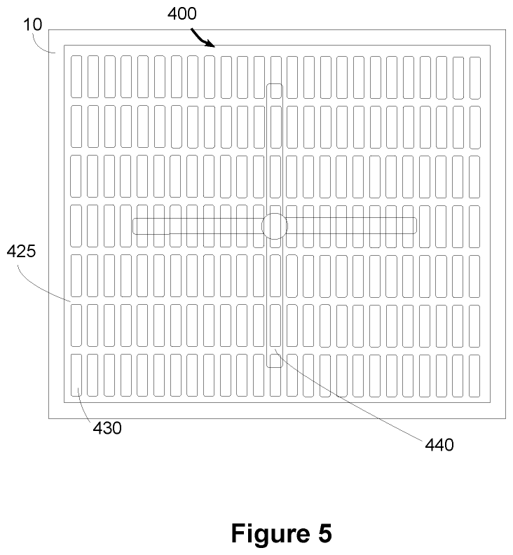

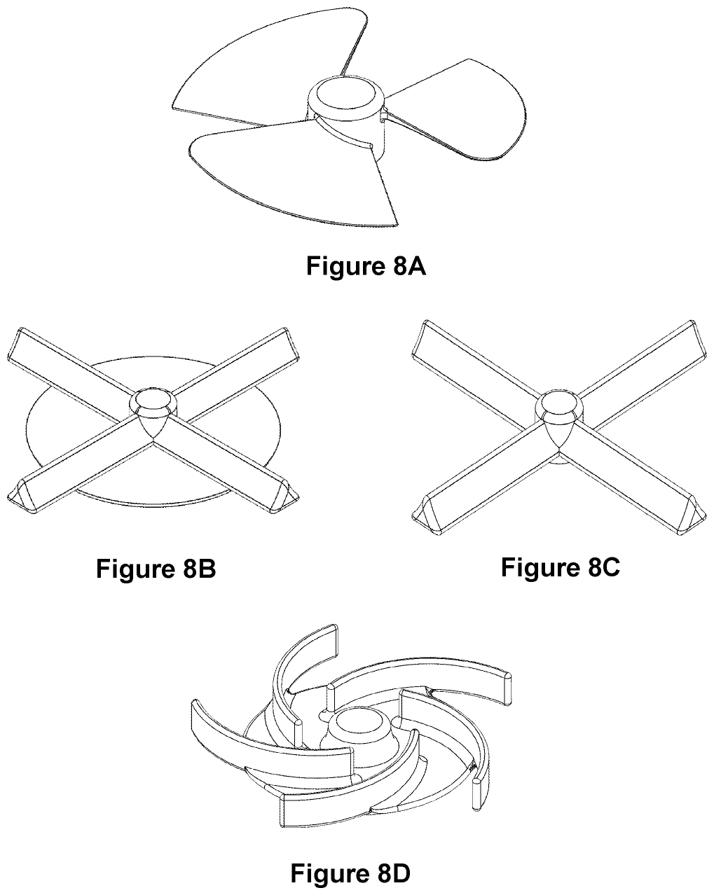

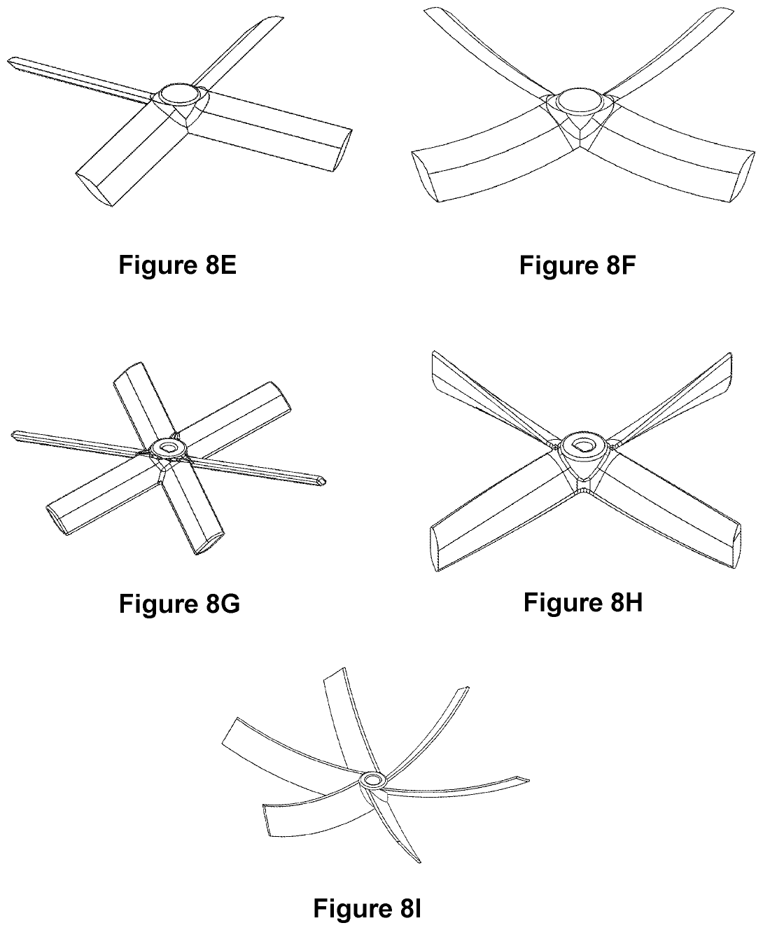

The container 400 may additionally include an agitator 420 to mix the liquid, allowing for greater control of the temperature of the liquid and more uniform heating. The agitator 420 may project through a bottom wall 402 of the body 410 into the container 400. The agitator 420 may include a first end 422 contained within the body 410 of the container 400 and a second end 424 that is located outside of the body 410. The first end 422 of the agitator 420 may include a propeller 440 (as illustrated in FIGS. 4 and 5); however, this is not intended to be limiting, as in in other instances the first end 422 of the agitator 420 may include other designs for agitating the liquid. For example, FIGS. 8A-D illustrate additional exemplary designs for the first end 422 of the agitator 420 that may be used in the container 400. For example, the propeller is not limited to a four-blade embodiment, as illustrated in FIGS. 4 and 5; in some embodiments, the propeller may have three blades (FIG. 8A), or any other number of blades. As another example, the first end 422 of the agitator 420 may include a paddle, as illustrated in FIGS. 8B-C, for mixing the liquid. In yet another example, the first end 422 of the agitator may include a centrifugal mixer, as illustrated in FIG. 8D, for agitating the liquid. In some instances, the first end 422 of the agitator 420 may include a bidirectional propeller, such as illustrated FIGS. 8E-H. In other instances, the first end 422 of the agitator 420 may include one or more upwardly curved blades, as illustrated in FIGS. 8F and 8I. In still other instances, the first end 422 of the agitator 420 may include one or more twisted blades, as illustrated in FIG. 8H.

The second end 424 of the agitator 420 may be adapted to couple with a turntable drive 435 of a microwave oven to power movement of the agitator 420 in response to rotation of the turntable drive 435. In some instances, this movement is rotational; however, the movement is not limited to rotation, as in other instances, the movement may be vibrational. In some instances, there may be a rotary seal 426 between the first end 422 and the second end 424 of the agitator 420 that seals the bottom wall 402 of the body 410, whereby the agitator 420 projects through rotary seal 426 in order to prevent or minimize fluid leakage. Additionally, the container may include one or more supports 460 to hold the bottom 402 of the container 400 above the bottom of the microwave cavity 10 so that it may engage the turntable drive 435. In some instances, this support 460 may be, as illustrated in FIG. 4, legs at the corners of the container 400; while in other instances, the support 460 may be a lip that extends all the way around the bottom 402 of the container 400.

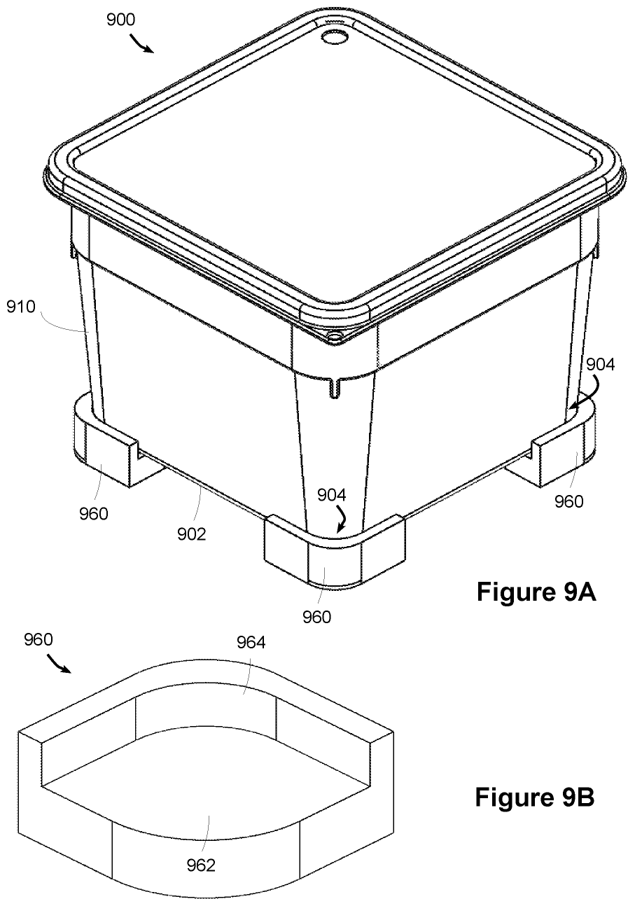

Referring now to FIGS. 9A-B, where an exemplary embodiment of container supports 960 are illustrated in detail. FIG. 9A illustrates another embodiment of a container 900 for use in a microwave oven (e.g. for sous vide cooking). Similar to the embodiment illustrated with reference to FIGS. 4-6A, the container 900 may include a body 910 for containing a liquid to be mixed. Container 900 may also include an agitator (not illustrated) that may project through a bottom wall 902 of the body 910 into the container 900. In some instances, the agitator may produce a rotating force on the container 900; this rotational force may be amplified as a result of friction from the rotary seal. It is generally desirable for the container 900 to remain substantially stationary, so that the propeller may impart vertical force on the water in order to mix the water vertically, thereby minimizing the temperature gradient. The supports 960 illustrated in FIGS. 9A-B may minimize the rotation of the container 900. These supports 960 include a platform 962 upon which the bottom wall 902 of the container 900 may sit. The supports 960 may also include a protrusion 964 extending upward toward the container 900 along approximately one-half of the perimeter of the support 900. The protrusion 964 may be configured to couple or mate with the corner 904 of the container 900, so as to support the container and minimize any rotational movement of the container 900.

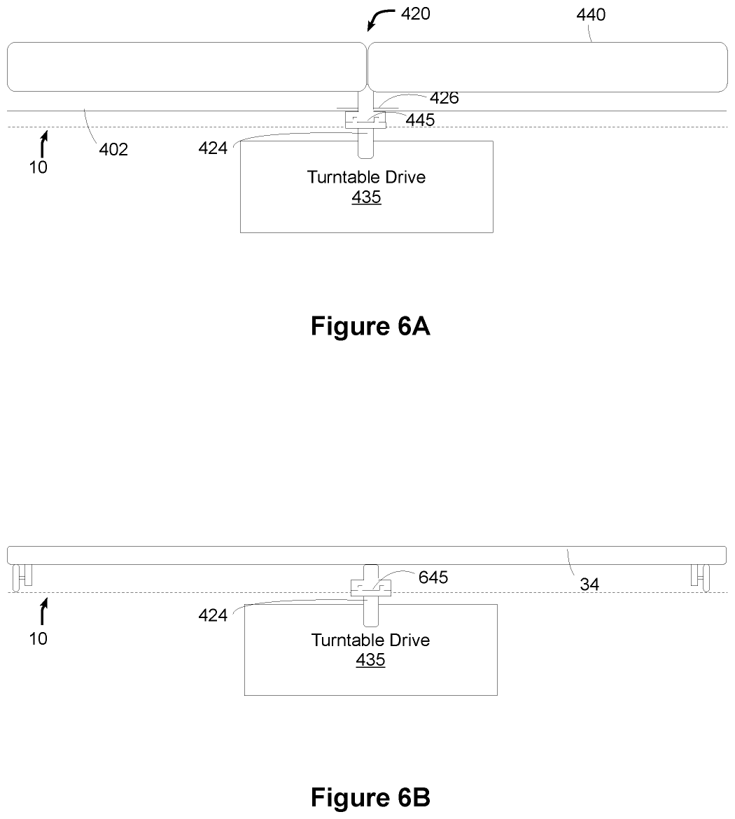

In some instances, such as illustrated in FIG. 6A, the second end 424 of the agitator 420 may include a connector 445 that is able to removably couple with the turntable drive 435 of the microwave oven 10. In such instances, a mating profile of the container connector 445 may match a mating profile of the turntable connector 645. Such matching mating profiles may allow the container 400 to be interchangeable with the turntable 34 (see FIGS. 6A-B). It is to be understood that the mating portion of the connector 445 and the turntable 34, illustrated in FIGS. 6A-B respectively, are merely exemplary and are not to be construed as limiting. Different manufacturers, for example, may use different turntable connector profiles, and it will be appreciated that a container 400 consistent with the invention may include any number of different connector profiles for use in various brands and/or models of microwave ovens. Further, in some embodiments a container 400 may include multiple interchangeable connectors that are removably coupled to an agitator to enable the container to be customized for use with different brands or models of microwave ovens.

In some instances, the turntable drive 435 may operate by allowing rotation in either a clockwise or counter-clockwise direction; however, in many such instances, the direction of this rotation may be random and not controllable. Therefore, in some instances, it may be desirable for the agitator 420 to be a propeller with bidirectional features, such as any of those illustrated in FIGS. 8E-I, so that there may be sufficient reduction of the temperature gradient achieved in either rotational direction.

Returning to FIGS. 4-5, the container 400 may additionally include a cage 425 enclosing an area extending upward from the bottom 402 of the container 400 and surrounding the first end 422 of the agitator 420, including in the illustrated embodiment the propeller 440. The cage 425 itself may be formed of a microwave safe material (e.g. glass, plastic, or the like) and may include a plurality of openings 430 through which the fluid in the container 400 may flow. In some instances, the cage 425 may be permanently affixed to the container 400; while in other instances, the cage 425 be removable from the container 400, for example to facilitate cleaning. Although generally illustrated in FIG. 4 as small, equal-sized openings 430, this is not intended to be limiting, as the openings of the cage 425 may be any number of shapes and sizes; furthermore, the openings 430 of a single cage 425 are not limited to a single shape and size. Such a cage may be desirable in order to prevent the agitator 420, and more particularly in the illustrated embodiment the propeller 440, from entangling any large items disposed within the liquid. For example, the container 400 may be used in sous vide cooking in the microwave oven 10, and the cage 425 may separate the agitator 420 from a sous vide bag 450 in a submerged position within the liquid 415 contained by the container 400, preventing the agitator from entangling the sous vide bag 450 as it agitates the liquid.

Generally, during sous vide cooking, one or more food items are placed in a container 400 and immersed in water. The food items are usually placed bags or otherwise sealed such that the food items do not physically contact or mix with water. FIG. 4, for example, illustrates a sous vide bag 450 containing chicken breasts 455. In some instances, sous vide cooking in a microwave oven may require a specialized bag 450 in order to protect the food item inside from being cooked by the microwave energy when the microwave cooking element is on One such example of a specialized bag may be a bag constructed of BoPET (biaxially-oriented polyethylene terephthalate). BoPET is a polyester film constructed from stretched polyethylene terephthalate (PET), and is chemically and dimensionally stable with gas and aroma barrier properties, and/or electrical insulation properties. Various brands of BoPET are known in the art and may be used as the sous vide bag 450, for example, Mylar®, Melinex®, or Hostaphan® may be used to protect the food item from the microwave energy, but this is not intended to be limiting. In another example, the food item (e.g. chicken) may be wrapped in aluminum foil prior to being submerged in the water bath; the aluminum foil, similar to the BoPET, may protect the food item inside from being cooked by the microwave cooking element. It is generally desirable for air to be removed from each bag 450 prior to cooking, e.g., using a vacuum sealer or through manual expelling of air from the bag prior to closure, to minimize the buoyancy of the bag when immersed in the container of water. In some instances, the cage 425 may form a support surface for the sous vide bag 450, and in such instances, the bag 450 may sink to and rest on the cage 425 during cooking, with cage 425 separating bag 450 from the rotating agitator during cooking.

The container 400 illustrated in FIGS. 4-6A is merely illustrative. It is to be understood that in some instances, the container 400 may be larger or smaller in order to accommodate a particular size sous vide bag or a particular size microwave oven. It is also to be understood that the container 400 described herein may vary in shape; for example, in some instances, it may be desirable for the container to be spherical, cuboid or ovid in shape, among others. Further a container consistent with the invention may include additional structures, e.g., handles, covers or lids, structures to hold or otherwise secure food items or bags, or structures to keep buoyant food items or bags submerged within the water bath during cooking.

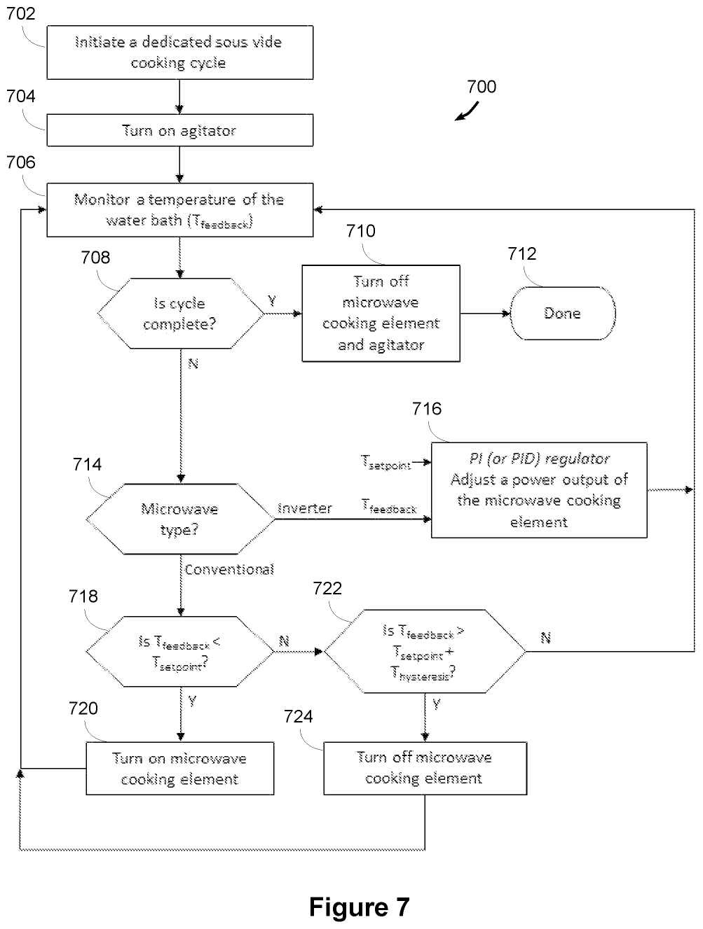

Now turning to FIG. 7, an example embodiment of an operational flow 700 for a sous vide cooking in microwave oven 10 using container 400 is described herein. In block 702, a dedicated sous vide cooking cycle is initiated by the controller in response to user input. The user may also place a sous vide container (described with reference to FIG. 3-6A) containing a water bath into the cooking cavity. This user input may include only the selection of the dedicated sous vide cycle; however, in some instances the user may also select from various preprogramed options of food type (e.g. fish, beef, pork, etc.) being cooked via the sous vide cycle. In other instances, the user may also input how well the food is to be cooked (e.g. rare, medium rare, medium, medium well, etc.). The cooking temperature and cooking time may vary based on the user inputs, e.g. using predetermined temperatures and times associated with combinations of food types and how well the food is to be cooked, or based on manually input temperatures and/or times. In some instances, the water may be preheated to the desired temperature before the user places the container within the cooking cavity; however, this is not to be understood as limiting, as the dedicated sous vide cooking cycle may also be used to initially bring the water to the desired temperature, thus eliminating the need for preheating the water. Further, in some embodiments a sous vide cooking cycle may be configured to preheat the water prior to inserting the food into the water bath (i.e. with only water in the container), so the controller may be configured to pause the cooking cycle once the desired temperature of the water bath is reached and alert a user to insert the food into the container and restart the cooking cycle (while optionally maintaining the water bath at the desired temperature until the user has opened the microwave after being alerted to insert the food).

In block 704, the agitator is activated and begins mixing the water in the container in order to reduce the temperature gradient throughout the water. In block 706, the temperature sensor wirelessly monitors the temperature of the water bath within the sous vide container (T_{feedback})). At the initiation of the dedicated sous vide cooking cycle the microwave may heat the water to a desired temperature setpoint as determined by the various user inputs. The temperature sensor may then continue to monitor the temperature of the water bath throughout the cooking cycle. In some instances, a temperature measurement may be taken every minute; in other instances, a temperature measurement may be taken every five minutes, every ten minutes, every second, every few seconds, or any other higher or lower frequency. A uniform temperature throughout the water bath within the container may also be maintained through use of an agitator, which allows for even heating of the water bath.

In block 708 the controller determines if the dedicated sous vide cycle is complete. If the cycle is complete, in block 710 the microwave cooking element and the agitator may be turned off and the cooking may be done (block 712). If the cooking cycle is not complete, the remainder of the method 700 may vary based on the type of microwave oven. In block 714, the type of microwave oven is determined. Where the microwave oven is an inverter, a setpoint temperature (Tₛₑₜₚₒᵢₙₜ) may be provided to the proportional-integral-derivative regulator of the inverter microwave, after which in block 716 the power output of the microwave cooking element may be adjusted based on the monitored temperature (T_{feedback})). Temperature setpoint of the water bath may be a desired temperature, or a desired temperature range (e.g. within 1 or 2 degrees, or some other range). Block 716 passes control to block 706 and then to 708 continue monitoring the temperature and to determine if the cooking cycle is complete.

Where, in block 714, the type of microwave oven is determined to a conventional microwave oven, a determination may be made in block 718 of whether the temperature measured during monitoring (T_{feedback}) is less than the setpoint temperature (Tₛₑₜₚₒᵢₙₜ). In such instances, the setpoint temperature (Tₛₑₜₚₒᵢₙₜ) may be provided as part of initiating the dedicated sous vide cycle. Where the temperature measured during monitoring (T_{feedback}) is less than the setpoint temperature (Tₛₑₜₚₒᵢₙₜ), control may then pass to block 720, where the microwave cooking element is activated. Block 720 may then pass control to block 706 and then to block 708 to continue monitoring the temperature and to determine if the cooking cycle is complete. However, where the temperature measured during monitoring (T_{feedback}) is not less than the setpoint temperature (Tₛₑₜₚₒᵢₙₜ), control may then pass to block 722, where it is determined whether the temperature measured during monitoring (T_{feedback}) is greater than the setpoint temperature (Tₛₑₜₚₒᵢₙₜ) in combination with the hysteresis temperature (T_{Hysteresis}). If the temperature measured during monitoring (T_{feedback}) is greater than the setpoint temperature (Tₛₑₜₚₒᵢₙₜ) in combination with the hysteresis temperature (T_{Hysteresis}), the microwave cooking element is deactivated (block 724). Block 724 may then pass control to block 706 and then to block 708 to continue monitoring the temperature and to determine if the cooking cycle is complete. However, if the temperature measured during monitoring (T_{feedback}) is not greater than the setpoint temperature (Tₛₑₜₚₒᵢₙₜ) in combination with the hysteresis temperature (T_{Hysteresis}), block 722 may then pass control to block 706 and then to 708 continue monitoring the temperature and to determine if the cooking cycle is complete.

Some cycling on or off of the microwave cooking element in order to increase or decrease the temperature of the water bath as needed to maintain the desired temperature or range of temperatures. Once the water bath has reached the desired temperature, the microwave cooking element may still need to be cycled on a many times each hour in order to maintain the desired temperature; however, the size of the container, the volume of water, the effectiveness of heat retention of the container, etc. may all effect the length and number of times the microwave cooking element needs to be cycled on or off. In other instances, controlling of the microwave cooking element may include adjusting the power output of the microwave cooking element in order to raise or lower the temperature of the water bath. In some embodiments a combination of varying the power output and varying the duty cycle of the microwave cooking element may also be used.

Although described in terms of reaching a desired temperature or temperature range, this is not intended to be limiting, as in some instances it may be desirable for the dedicated sous vide cycle to follow a preprogramed cooking cycle where the temperature of the water bath is held at different temperatures at different times. Different foods, for example, may have different preprogrammed cooking profiles that are designed to hold the water bath at different temperatures at different points in a cooking cycle.

It will be appreciated that various modifications may be made to the embodiments discussed herein, and that a number of the concepts disclosed herein may be used in combination with one another or may be used separately. Therefore, the invention lies in the claims hereinafter appended.

What is claimed is:

1. A method of sous vide cooking in a microwave oven, wherein the microwave oven includes a housing including a cooking cavity, a microwave cooking element disposed within the housing to generate cooking energy within the cooking cavity, a turntable drive projecting into the cooking cavity and a controller disposed in the housing, the method comprising:
initiating, by the controller, a cooking cycle to cook a food item disposed in a container located in the cooking cavity;
circulating water in a water bath disposed in the container during the cooking cycle by driving the turntable drive to drive an agitator that is removably coupled to the turntable drive, that projects through a bottom wall of the container, and that is separated from the food item by a cage that surrounds a portion of the agitator disposed within the container;
monitoring, by a temperature sensor, a temperature of the water bath disposed in the container during the cooking cycle; and
controlling, by the controller, the microwave cooking element in response to the monitored temperature to maintain a substantially constant temperature for the water bath during at least a portion of the cooking cycle.

2. The method of claim 1, wherein the cooking cycle is a dedicated sous vide cycle.

3. The method of claim 1, wherein the agitator includes a first end disposed within the container and a second end disposed external to the container, the second end including a connector adapted to removably couple with the turntable drive of the microwave oven to power movement of the agitator in response to rotation of the turntable drive.

4. The method of claim 3, wherein a mating profile of the connector matches that of a turntable of the microwave oven.

5. The method of claim 1, wherein the temperature sensor is an infrared sensor.

6. The method of claim 5, wherein the temperature sensor is disposed on a back wall or a side wall of the cooking cavity.

7. The method of claim 1, wherein the monitoring of the temperature of the water bath is conducted wirelessly.

8. The method of claim 1, wherein the temperature sensor is a wireless temperature sensor and the wireless temperature sensor is wirelessly coupled with controller.

9. The method of claim 1, wherein the microwave oven is an inverter-type microwave oven.

10. The method of claim 1, wherein the microwave oven is a conventional-type microwave oven.

11. A method of sous vide cooking in a microwave oven, wherein the microwave oven includes a housing including a cooking cavity, a microwave cooking element disposed within the housing to generate cooking energy within the cooking cavity, and a controller disposed in the housing, the method comprising:
initiating, by the controller, a cooking cycle to cook a food item disposed in a container located in the cooking cavity;
monitoring, by a wireless temperature sensor, a temperature of a water bath disposed in a container during the cooking cycle;
determining, by the controller, a microwave oven type; and
controlling, by the controller, the microwave cooking element in response to the wirelessly monitored temperature and in response to the determination of the microwave oven type to maintain a substantially constant temperature for the water bath during at least a portion of the cooking cycle.

12. The method of claim 11, wherein when the microwave oven type is determined to be a conventional microwave oven type the method further includes:
comparing, by the controller, the temperature of the water bath disposed in the container to a setpoint temperature;
wherein when the temperature of the water bath disposed in the container is less than the setpoint temperature, activating the microwave cooking element; and
continue monitoring, by the wireless temperature sensor, the temperature of the water bath disposed in the container during the cooking cycle.

13. The method of claim 12, wherein the setpoint temperature is provided as a part of initiating the cooking cycle.

14. The method of claim 11, wherein when the microwave oven type is determined to be a conventional microwave oven type the method further includes:
comparing, by the controller, the temperature of the water bath disposed in the container to a setpoint temperature;
wherein when the temperature of the water bath disposed in the container is not less than the setpoint temperature, determining if the temperature of the water bath disposed in the container is greater than the setpoint temperature in combination with a hysteresis temperature;
wherein when the temperature of the water bath disposed in the container is greater than the setpoint temperature in combination with the hysteresis temperature, deactivating the microwave cooking element; and
continue monitoring, by the wireless temperature sensor, the temperature of the water bath disposed in the container during the cooking cycle.

15. The method of claim 11, wherein when the microwave oven type is determined to be an inverter type microwave oven, the method further includes:
providing a setpoint temperature to a regulator of the inverter type microwave oven;
adjusting, based on the monitored temperature of the water bath disposed in the container, a power output of the microwave cooking element; and
continue monitoring, by the wireless temperature sensor, the temperature of the water bath disposed in the container during the cooking cycle.

16. The method of claim 15, wherein the regulator is a proportional-integral-derivative regulator.

17. The method of claim 11, wherein the wireless temperature sensor is an infrared sensor.

18. The method of claim 11, wherein the wireless temperature sensor is disposed on a back wall or a side wall of the cooking cavity.

19. The method of claim 11, wherein the cooking cycle is a dedicated sous vide cycle.

20. A method of sous vide cooking in a microwave oven, wherein the microwave oven includes a housing including a cooking cavity, a microwave cooking element disposed within the housing to generate cooking energy within the cooking cavity, and a controller disposed in the housing, the method comprising:
initiating, by the controller, a cooking cycle to cook a food item disposed in a container located in the cooking cavity;
monitoring, by a wireless temperature sensor, a temperature of a water bath disposed in the container during the cooking cycle;
comparing, by the controller, the temperature of the water bath disposed in the container to a setpoint temperature;
determining, by the controller, a microwave oven type; and
controlling, by the controller, the microwave cooking element in response to the wirelessly monitored temperature compared to the setpoint temperature and in response to the determination of the microwave oven type to maintain a substantially constant temperature for the water bath during at least a portion of the cooking cycle.
